(19) United States
(12) Patent Application Publication
(10) Pub. No.: US 2012/0070014 A1
(43) Pub. Date: Mar. 22, 2012

(54) SAFE EARPHONE SYSTEM AND METHOD OF DRIVING THE SAME

(75) Inventor: Kwon Hue Choi, Gyeongsan-si (KR)

(73) Assignee: INDUSTRY-ACADEMIC COOPERATION FOUNDATION, YEUNGNAM UNIVERSITY, Gyeongsan-si (KR)

(21) Appl. No.: 12/885,651

(22) Filed: Sep. 20, 2010

(51) Int. Cl. H04R 1/10

(52) U.S. Cl. 381/74

(57) ABSTRACT

Provided are a safety earphone system and a method of driving the same. The safe earphone system includes a microphone block that includes: a sound input terminal for receiving sound information from a sound system; a sound output terminal for receiving the sound information and transmitting the sound information to an earphone; a microphone unit for detecting an outside sound; and a controller for decreasing the sound information volume or blocking a connection between the sound output terminal and the sound input terminal if a level of the outside sound detected by the microphone unit exceeds a threshold value. Accordingly, an output state of the earphone is adjusted according to a level of the outside sound detected by a microphone module. In other words, a user may hear the outside sound while wearing the earphone since the sound information transmitted to the earphone is blocked if the level of the outside sound exceeds the threshold value. Thus, the user listens to important ambient sounds at a predetermined level or above while receiving the sound information, without having to remove the earphone. Also, the safety earphone system may be simply and easily applied to a conventional earphone or headset without having to largely change a structure of the conventional earphone or headset.

### BACKGROUND OF THE INVENTION

1. Field of the Invention

The present invention relates to a safe earphone system and a method of driving the same, and more particularly, to a safe earphone system for adjusting an output state of an earphone according to a detected level of an outside sound, and a method of driving the same.

2. Description of the Related Art

Purposes of using earphones or headsets are classified into two kinds. A first purpose is to enable a user to only listen to a sound so that the sound does not disturb other people. A second purpose is to enable the user to listen to the sound clearly by blocking an ambient noise.

Here, the user may listen to the sound in a relatively high level while somewhat blocking the ambient noise by using an earphone or a headset, but an important ambient sound may be blocked with the ambient noise. For example, the user may miss a honk of a car, an urgent voice of a person around the user, an alarm bell, or an emergency broadcast on a street or a public place like a park or a library. Also, the user may miss a sound calling the user, a phone ring, or a knock in an office.

Also, if the user is using an earphone or a headset for the first purpose, the user only wants to block a little noise and does not want to block an important ambient sound. Moreover, an increasing number of young people, who use MP3s and iPods, use earphones and headsets for the first purpose.

### SUMMARY OF THE INVENTION

The present invention provides a safe earphone system for adjusting an output state of an earphone according to a detected level of an outside sound, and a method of driving the same.

According to an aspect of the present invention, there is provided a safe earphone system including a microphone block that includes: a sound input terminal for receiving sound information from a sound system; a sound output terminal for receiving the sound information and transmitting the sound information to an earphone; a microphone unit for detecting an outside sound; and a controller for decreasing the sound information volume or blocking a connection between the sound output terminal and the sound input terminal if a level of the outside sound detected by the microphone unit exceeds a threshold value.

The microphone block may further include a microphone terminal for receiving the outside sound detected by the microphone unit, wherein the controller may output the outside sound to the earphone by connecting the microphone terminal and the sound output terminal or add the outside sound to the sound information if the level of the outside sound exceeds the threshold value. Also, the controller may decrease the sound information volume or block the connection between the sound output terminal and the sound input terminal for a predetermined setup time and connect the microphone terminal and the sound output terminal for the predetermines setup time. Here, the controller may set the predetermined setup time. Also, the threshold value may be set according to an ambient noise level collected by the microphone unit.

The microphone block may further include a filter unit for filtering a sound corresponding to an audible frequency from the outside sound detected by the microphone unit and transmitting the filtered sound to the controller. The microphone block may further include a battery unit for supplying power of the microphone block, wherein the battery unit may be charged by using an electric signal of the sound information received through the sound input terminal, while the sound information is transmitted to the earphone.

The microphone block may be connected between the earphone and the sound system.

The microphone unit may be a microphone installed to the earphone, and may stop detecting the outside sound if the microphone is used as a voice transmitter for a telephone conversation.

According to another aspect of the present invention, there is provided a method of driving a safe earphone system, the method including: receiving sound information from a sound system and transmitting the sound information to an earphone; receiving an outside sound detected by a microphone unit; comparing a level of the outside sound with a threshold value; and decreasing the sound information volume or blocking the sound information from being transmitted to the earphone if the level of the outside sound exceeds the threshold value. The method may further include outputting the outside sound to the earphone if the level of the outside sound exceeds the threshold value. The blocking may include blocking the sound information from being transmitted to the earphone for a predetermined setup time.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a safe earphone system according to an embodiment of the present invention;

FIG. 2 is a diagram of a microphone block of FIG. 1;

FIG. 3 is diagrams for describing state changes of the microphone block of FIG. 1, according to detection of an outside sound;

FIG. 4 is a flowchart illustrating a method of driving the safe earphone system of FIG. 1;

FIG. 5 is a diagram of a safe earphone system according to another embodiment of the present invention;

FIG. 6 is a diagram of a mode selecting module of FIG. 5;

FIG. 7 is diagrams for describing state changes of the mode selecting module of FIG. 5, according to detection of an outside sound; and

FIG. 8 is a flowchart illustrating a method of driving the safe earphone system of FIG. 5.

### DETAILED DESCRIPTION OF THE INVENTION

Hereinafter, the present invention will be described more fully with reference to the accompanying drawings, in which exemplary embodiments of the invention are shown.

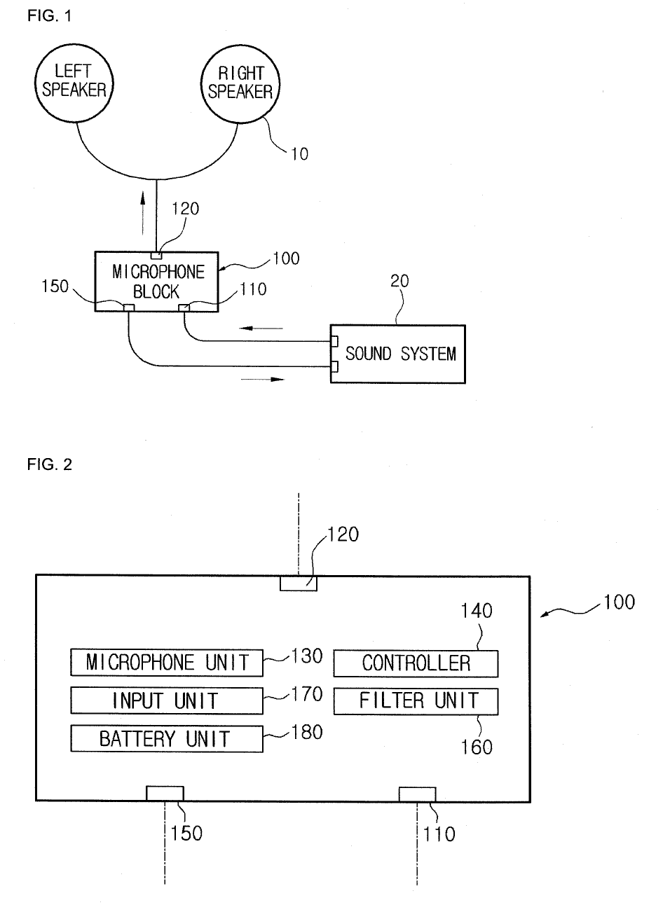

FIG. 1 is a diagram of a safe earphone system according to an embodiment of the present invention, and FIG. 2 is a diagram of a microphone block 100 of FIG. 1. Referring to FIGS. 1 and 2, the safe earphone system according to the current embodiment of the present invention includes the microphone block 100. The microphone block 100 is connected between an earphone 10 and a sound system 20, and includes a sound input terminal 110, a sound output terminal 120, a microphone unit 130, and a controller 140.

The sound input terminal 110 receives sound information from the sound system 20. Examples of the sound system 20 not only include general audio equipment, but also include a mobile phone having an audio function, a personal computer (PC), an MP3, a personal digital assistant (PDA), a portable multimedia player (PMP), a play station portable (PSP), a digital multimedia broadcasting (DMB), and a television (TV).

The sound output terminal 120 receives the sound information through the sound input terminal 110, and transmits the sound information to the earphone 10. Also, the microphone unit 130 detects outside sounds. Here, it is obvious that examples of the earphone 10 include not only general earphones, but also a headset having an earphone function, and ear sets, such as a wired hands free headset, a wired hands free ear set, a Bluetooth headset, and a Bluetooth ear set.

Also, when the microphone block 100 is applied to earphones, such as conventional handsfrees, headsets for an internet telephone, and headsets for an online chat, which basically have a microphone for its function, the microphone unit 130 uses or shares the microphone included in the earphones. Accordingly, when the microphone included in the earphones is used to transmit a voice for a telephone conversation, the microphone may be stopped from detecting the outside sounds.

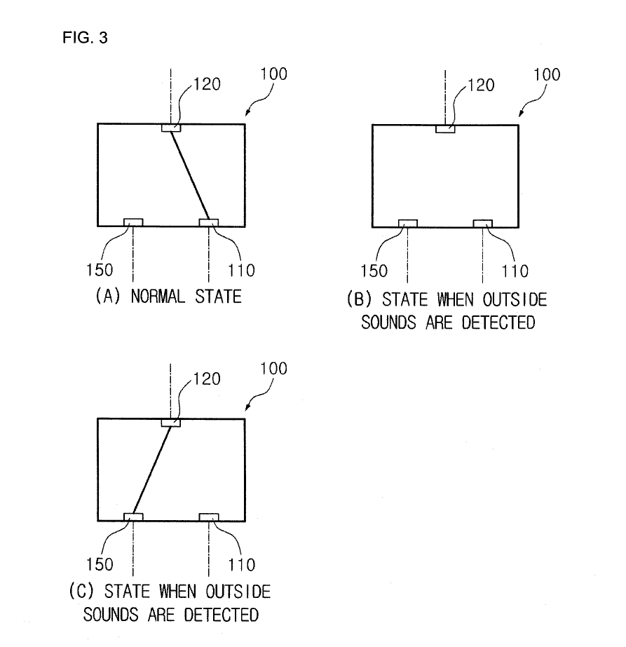

FIG. 3 is diagrams for describing state changes of the microphone block 100 of FIG. 1, according to detection of the outside sounds. Referring to FIGS. 1 through 3, when a level of the outside sounds detected by the microphone unit 130 does not exceed a predetermined threshold value, the controller 140 maintains a state shown in FIG. 3 (a) so that the sound information is continuously transmitted to the earphone 10. Also, referring to FIG. 3 (b), when the level of the outside sounds detected by the microphone unit 130 exceeds the predetermined threshold value, the controller 140 blocks a connection between the sound output terminal 120 and the sound input terminal 110 so that the sound information is not output to the earphone 10.

Here, the outside sounds may be heard for a predetermined setup time, for example, for T seconds, as the controller 140 blocks the connection between the sound output terminal 120 and the sound input terminal 110 for the predetermined setup time. Also, after the predetermined setup time, the sound output terminal 120 and the sound input terminal 110 are connected again, and thus the sound information is re-transmitted to the earphone 10. When the predetermined setup time is not applied, the sound information is unlimitedly blocked, and thus a user has to manually turn back the safe earphone system to an earphone mode if the outside sounds are not important sounds. Accordingly, so as to remove such inconvenience, the controller 140 automatically switches the safe earphone system from an earphone blocking mode to the earphone mode after the predetermined setup time.

The controller 140 may set the predetermined setup time. The controller 140 may set the predetermined setup time according to a time received from the user through an input unit 170.

As such, when the microphone unit 130 detects the outside sounds that are equal to or above a predetermined level, the controller 140 blocks the sound information from being transmitted to the earphone 10 for the predetermined setup time, and thus the outside sounds are heard while wearing the earphone 10. Accordingly, the user may hear an important ambient sound that is equal to or above the predetermined level while receiving the sound information through the earphone 10 without having to remove the earphone 10. For example, the important ambient sound may be a honk of a car, an urgent voice of a person around the user, an alarm bell, or an emergency broadcast on a street or a public place like a park or a library, or a sound calling the user, a phone ring, or a knock in an office.

Alternatively, when the level of the outside sounds detected by the microphone unit 130 exceeds the predetermined threshold level, the controller 140 may maintain the connection between the sound output terminal 120 and the sound input terminal 110 and provide the sound information to the earphone 10 for the predetermined setup time after decreases an output level of the sound information. In other words, based on the level of the outside sounds that exceeds the predetermined threshold value, the controller 140 may decrease the sound information volume for the predetermined setup time and add the outside sound to the sound information.

As described above, since the microphone block 100 may be selectively added to a conventional earphone, headset, or the like without having to change a structure of the conventional earphone, headset, or the like, manufacturing costs are not remarkably increased. Demands for earphones and headsets are increasing with a high distribution rate of various sound systems, and thus it is expected that utility of a system using the microphone block 100 would also increase.

The microphone block 100 includes a microphone terminal 150 for receiving the outside sounds detected by the microphone unit 130. Here, referring to FIG. 3 (c), when the level of the outside sounds exceeds the predetermined threshold value, the controller 140 connects the microphone terminal 150 and the sound output terminal 120 so that the outside sounds are directly output to the earphone 10. Here, the controller 140 connects the microphone terminal 150 and the sound output terminal 120 for the predetermined setup time so that the outside sounds are heard for the predetermined setup time.

In this case, the outside sounds are clearly and quickly heard compared to a state illustrated in FIG. 3 (b), and thus an external situation is quickly determined and a quick and effective response is possible when an emergency is occurred. Of course at this time, the controller 140 may adjust the output level of the outside sounds output to the earphone 10. For example, when a level of the outside sounds detected by the controller 140 is high, the output level of the outside sounds output to the earphone 10 may also be high.

The controller 140 sets the predetermined threshold value according to an ambient noise level collected through the microphone unit 130. As the ambient noise level increases, an outside sound detecting ability of the microphone unit 130 deteriorates. Thus, the controller 140 sets the predetermined threshold value high when the ambient noise level is high, thereby effectively detecting the outside sounds.

Alternatively, as the ambient noise level decreases, the outside sound detecting ability of the microphone unit 130 increases. Accordingly, the controller 140 sets the predetermined threshold value low when the ambient noise level is low, thereby effectively detecting the outside sounds even when the predetermined threshold value is low.

Besides, the microphone block 100 includes the input unit 170 for receiving the predetermined threshold value from the user. Since a hearing ability and sound level preference differ according to people, the user may directly set the predetermined threshold value according to his/her hearing, preference, etc.

Also, as described above, the predetermined setup time may be set through the input unit 170. In other words, the user may directly set the predetermined setup time, which is an earphone blocking time, through the input unit 170 according to his/her preference or a type of the outside sound to be cautious.

Referring to FIG. 2, the microphone block 100 includes a filter unit 160 for filtering a sound corresponding to an audible frequency from among the outside sounds detected by the microphone unit 130, and transmitting the filtered sound to the controller 140. When a level of a sound exceeding the audible frequency exceeds the predetermined threshold value, the sound cannot be heard by human, and thus the user may mistake the microphone block 100 for malfunction, and the microphone block 100 consumes unnecessary power. In other words, only the sound within the audible frequency is detected by using the filter unit 160, thereby increasing management efficiency of the microphone block 100.

The microphone block 100 includes a battery unit 180 for providing power of the microphone block 100. Examples of the battery unit 180 include a generally used small disposable battery, and a rechargeable battery. When an earphone having a Bluetooth function is used, the microphone block 100 may share a battery in the Bluetooth type earphone 10.

While the sound information is transmitted to the earphone 10, the battery unit 180 is charged by using an electric signal of the sound information input through the sound input terminal 110. In other words, since the sound information input from the sound system 20 to the earphone 10 is an electric signal, the battery unit 180 may be charged by using the electric signal of the sound information. In this case, a power input unit for charging a battery may not be separately needed. Also, generally, the sound information is stably heard for several minutes once, and thus the battery unit 180 may be stably charged within limits of not remarkably exhausting the power of the sound information.

Meanwhile, the microphone block 100 may be connected to the sound system 20 with or without a wire. When the microphone block 100 is connected to the sound system 20 with a wireless, any one of various well known wireless communication methods may be used.

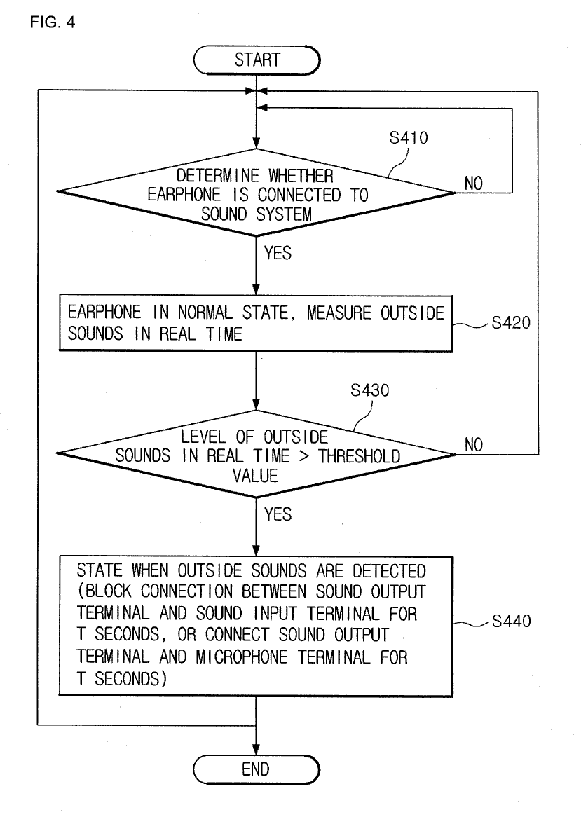

FIG. 4 is a flowchart illustrating a method of driving the safe earphone system of FIG. 1. The method will now be described with reference to FIGS. 1 through 4. First, the microphone block 100 determines whether the earphone 10 is connected to the sound system 20 in operation S410, and determines that the earphone 10 is normally operating when the earphone 10 is connected to the sound system 20.

Then, the microphone block 100 receives the sound information from the sound system 20 and transmits the received sound information to the earphone 10. Accordingly, the microphone block 100 transmits the sound information received through the sound input terminal 110 to the earphone 10 through the sound output terminal 120. Here, the microphone block 100 is in the state shown in FIG. 3(a). Also, the controller 140 continuously receives the outside sounds detected by the microphone unit 130 in real time, in operation S420.

At the same time, the controller 140 continuously compares the level of the outside sounds with the predetermined threshold value in real time, in operation S430.

When it is determined that the level of the outside sounds exceed the predetermined threshold value, the controller 140 blocks the connection between the sound input terminal 110 and the sound output terminal 120 for the predetermined setup time, thereby blocking the sound information from being transmitted to the earphone 10, in operation S440. Accordingly, the microphone block 100 is switched from the state shown in FIG. 3 (a) to the state shown in FIG. 3 (b) or (c), according to control of the controller 140. In the state shown in FIG. 3 (c), the connection between the sound input terminal 110 and the sound output terminal 120 is blocked, and at the same time, the outside sounds are directly output to the earphone 10 according to the control of the controller 140.

On the other hand, when it is determined that the level of the outside sounds is below the predetermined threshold value, the controller 140 maintains the connection between the sound input terminal 110 and the sound output terminal 120 in the state shown in FIG. 3(a), thereby continuing a normal operation of the earphone 10 (operations S410 and S420).

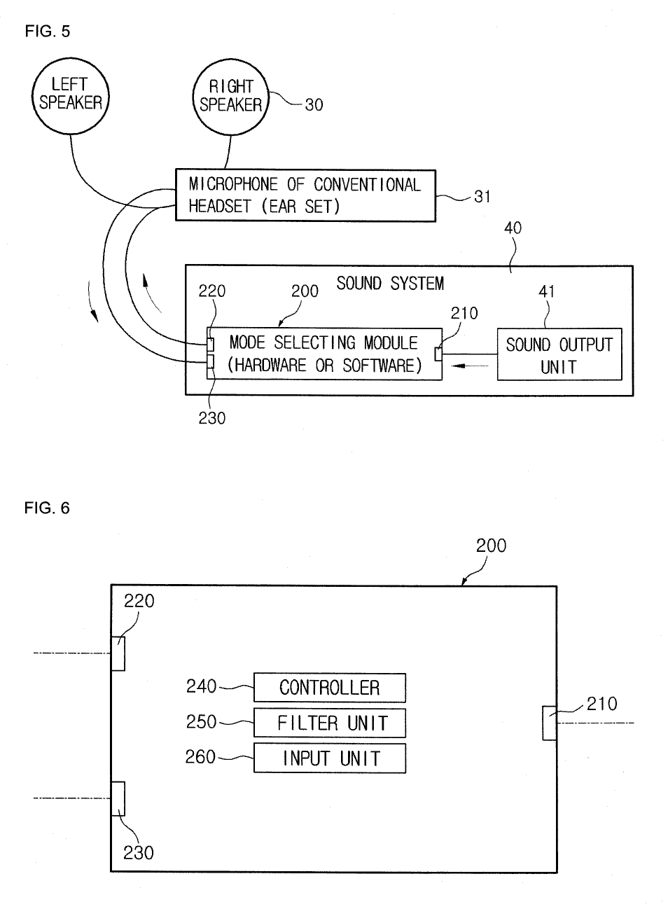

FIG. 5 is a diagram of a safe earphone system according to another embodiment of the present invention, and FIG. 6 is a diagram of a mode selecting module 200 of FIG. 5. Referring to FIGS. 5 and 6, the safe earphone system according to the current embodiment of the present invention includes the mode selecting module 200. A sound system 40 is built inside the mode selecting module 200.

The mode selecting module 200 includes a sound input terminal 210, a sound output terminal 220, a microphone terminal 230, and a controller 240. The sound input terminal 210 is connected to a sound output unit 41 included in the sound system 40, and receives sound information from the sound output unit 41. Here, the sound system 40 may be any one of the examples of the sound system 20 described above.

The sound output terminal 220 receives the sound information input through the sound input terminal 210, and transmits the sound information to an earphone 30. The microphone terminal 230 is connected to a microphone 31 installed to the earphone 30, and receives outside sounds detected by the microphone 31. Here, the microphone 31 corresponds to the microphone unit 130 of FIG. 2. Of course, the mode selecting module 200 may be connected to the earphone 30 and the microphone 31 with or without a wire.

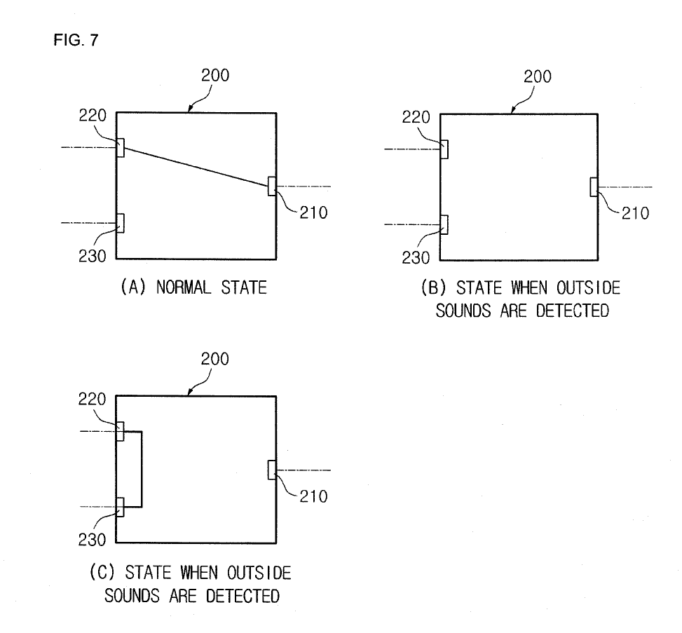

FIG. 7 is diagrams for describing state changes of the mode selecting module 200 of FIG. 5, according to detection of an outside sound. Referring to FIGS. 5 through 7, when a level of the outside sounds detected by the microphone terminal 230 does not exceed a predetermined threshold value, the controller 240 maintains a state shown in FIG. 7 (a), so that the sound information is continuously transmitted to the earphone 30.

Also, referring to FIG. 7 (b), when the level of the outside sounds detected by the microphone terminal 230 exceeds the predetermined threshold value, the controller 240 blocks connection between the sound input terminal 210 and the sound output terminal 220 for a predetermined setup time (T seconds), so that the sound information is not output to the earphone 30. An effect of a state shown in FIG. 7 (b) is identical to that shown in FIG. 4 (b).

Alternatively, when the level of the outside sounds detected by the microphone terminal 230 exceeds the predetermined threshold value, the controller 240 may maintain the connection between the microphone terminal 230 and the sound output terminal 220 and provide the sound information to the earphone 30 after reducing an output level of the sound information for the predetermined setup time.

Then, referring to FIG. 7 (c), when the level of the outside sounds exceed the predetermined threshold value, the controller 240 connects the microphone terminal 230 and the sound output terminal 220 for the predetermined setup time so that the outside sounds are output to the earphone 30. An effect of a state shown in FIG. 7 (c) is identical to that shown in FIG. 4 (c). At this time, the controller 240 may also adjust the output level of the outside sounds output to the earphone 30. For example, when the level of the outside sounds detected by the controller 240 is high, the controller 240 may adjust the output level of the outside sounds to be high and transmit the outside sounds to the earphone 30.

The controller 240 sets the predetermined threshold value according to an ambient noise level collected through the microphone terminal 230. An effect of adjusting the predetermined threshold value according to the ambient noise level has been described above.

The mode selecting module 200 also includes an input unit 260 and a filter unit 250. A user sets the predetermined threshold value and the predetermined setup time through the input unit 260. The filter unit 250 filters a sound corresponding to an audible frequency from among the outside sounds detected by the microphone terminal 230, and transmits the filtered sound to the controller 240. Effects of the input unit 260 and the filter unit 250 have been described above with reference to the input unit 170 and the filter unit 160 of FIG. 2.

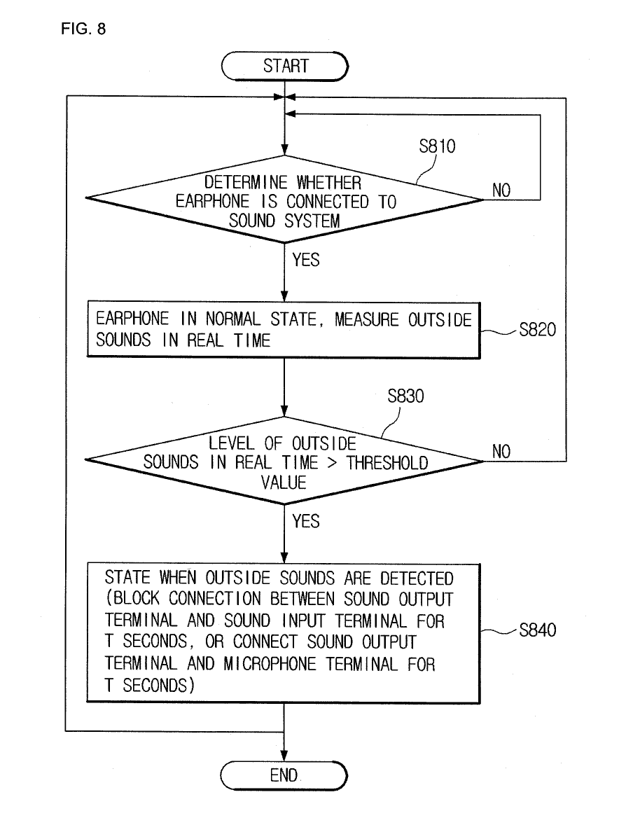

FIG. 8 is a flowchart illustrating a method of driving the safe earphone system of FIG. 5. The method will now be described with reference to FIGS. 5 through 8. First, the mode selecting module 200 determines whether the earphone 30 is connected to the sound system 40 in operation S810, and determines that the earphone 30 is normally operating when the earphone 30 is connected to the sound system 40.

Then, the mode selecting module 200 receives the sound information from the sound output unit 41 included in the sound system 40, and transmits the sound information to the earphone 30. Accordingly, the mode selecting module 200 transmits the sound information from the sound output unit 41 to the earphone 30 in a normal state. Here, the mode selecting module 200 is in the state shown in FIG. 7 (a). Also, the controller 240 continuously receives the outside sounds detected by the microphone terminal 230 in real time, in operation S820.

At the same time, the controller 240 continuously compares the level of the outside sounds with the predetermined threshold value in real time, in operation S830.

As a result of the comparison, when the level of the outside sounds exceed the predetermined threshold value, the controller 240 blocks the connection between the sound input terminal 210 and the sound output terminal 220 for the predetermined setup time, thereby blocking the sound information from being transmitted to the earphone 30, in operation S840. Accordingly, the mode selecting module 200 is switched from the state of FIG. 7 (a) to the state shown in FIG. 7 (b) or (c), according to control of the controller 240. In the state of FIG. 7 (c), the connection between the sound input terminal 210 and the sound output terminal 220 are blocked, and at the same time, the outside sounds are directly output to the earphone 30 according to control of the controller 240.

Alternatively, as the result of the comparison, when the level of the outside sounds is below the predetermined threshold value, the controller 240 maintains the connection between the sound input terminal 210 and the sound output terminal 220 as shown in FIG. 7 (a), thereby continuing the normal state of the earphone 30 (operations S810 and S820).

According to a safe earphone system and a method of driving the same of the present invention, an output state of an earphone may be adjusted by using a microphone module, according to a detected level of outside sounds. In other words, when a level of the outside sounds exceed a predetermined threshold value, sound information transmitted to the earphone is blocked, so that a user hears the outside sounds while wearing the earphone. Accordingly, the user can easily listen to ambient important sounds in a predetermined level or above without having to remove the earphone while receiving the sound information. Also, the safe earphone system can be simply and easily applied to a conventional earphone or headset without largely changing a structure of the conventional earphone or headset.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A safe earphone system comprising a microphone block that comprises:
a sound input terminal for receiving sound information from a sound system;
a sound output terminal for receiving the sound information and transmitting the sound information to an earphone;
a microphone unit for detecting an outside sound; and
a controller for decreasing the sound information volume or blocking a connection between the sound output terminal and the sound input terminal if a level of the outside sound detected by the microphone unit exceeds a threshold value.

2. The safe earphone system of claim 1, wherein the microphone block further comprises a microphone terminal for receiving the outside sound detected by the microphone unit,
wherein the controller outputs the outside sound to the earphone by connecting the microphone terminal and the sound output terminal or adds the outside sound to the sound information
if the level of the outside sound exceeds the threshold value.

3. The safe earphone system of claim 2, wherein the controller decreases the sound information volume or blocks the connection between the sound output terminal and the sound input terminal for a predetermined setup time and connects the microphone terminal and the sound output terminal for the predetermines setup time.

4. The safe earphone system of claim 3, wherein the controller is capable of setting the predetermined setup time.

5. The safe earphone system of claim 1, wherein the threshold value is set according to an ambient noise level collected by the microphone unit.

6. The safe earphone system of claim 1, wherein the microphone block further comprises a filter unit for filtering a sound corresponding to an audible frequency from the outside sound detected by the microphone unit and transmitting the filtered sound to the controller.

7. The safe earphone system of claim 1, wherein the microphone block further comprises a battery unit for supplying power of the microphone block,
wherein the battery unit is charged by using an electric signal of the sound information received through the sound input terminal, while the sound information is transmitted to the earphone.

8. The safe earphone system of claim 1, wherein the microphone block is connected between the earphone and the sound system.

9. The safe earphone system of claim 1, wherein the microphone unit is installed to the earphone, and stops detecting the outside sound if the microphone is used as a voice transmitter for a telephone conversation.

10. A method of driving a safe earphone system, the method comprising:
receiving sound information from a sound system and transmitting the sound information to an earphone;
receiving an outside sound detected by a microphone unit;
comparing a level of the outside sound with a threshold value; and
decreasing the sound information volume or blocking the sound information from being transmitted to the earphone if the level of the outside sound exceeds the threshold value.

11. The method of claim 10, further comprising outputting the outside sound to the earphone or adding the outside sound to the sound information if the level of the outside sound exceeds the threshold value.

12. The method of claim 10, wherein the decreasing the sound information volume or blocking comprises decreasing the sound information volume or blocking the sound information from being transmitted to the earphone for a predetermined setup time.

13. The safe earphone system of claim 6, wherein the microphone block further comprises a battery unit for supplying power of the microphone block,
wherein the battery unit is charged by using an electric signal of the sound information received through the sound input terminal, while the sound information is transmitted to the earphone.

14. The safe earphone system of claim 2, wherein the microphone block is connected between the earphone and the sound system.

15. The safe earphone system of claim 2, wherein the microphone unit is installed to the earphone, and stops detecting the outside sound if the microphone is used as a voice transmitter for a telephone conversation.
